(19) United States
(12) Patent Application Publication
(10) Pub. No.: US 2012/0167473 A1
(43) Pub. Date: Jul. 5, 2012

(54) PANE UNIT AND METHOD FOR PRODUCING IT

(76) Inventor: Nikolaj Schapitz, Besigheim (DE)

(21) Appl. No.: 13/313,535

(22) Filed: Dec. 7, 2011

(30) Foreign Application Priority Data
Dec. 8, 2010 (DE) 10 2010 061 103.4

(51) Int. Cl. B60J 1/17; B60J 10/04

(52) U.S. Cl. 49/431; 49/506

(57) ABSTRACT

A pane unit for windows on motor vehicles including a first pane with a frame which has a profile and surrounds the margin of the pane on at least two sides. The frame engages on at least two sides of the pane or annularly surrounds the pane so as to be closed on itself, and the frame is formed from two profile parts with a primary part and with a secondary part. The primary part is formed as a hard component having a dimensional stability greater than that of the secondary part formed as a soft component. The primary part is formed along one longitudinal side of the first pane as a guide web for a second pane movable up and down therein, which guide web is arranged to point towards the first pane and engage thereon and has, on the opposite side, a window guide for the second pane.

The invention relates to a pane unit for windows on motor vehicles and the like, with a first pane which is surrounded at least partially by a frame with a frame profile, the frame consisting of two profile parts with a primary part and with a secondary part, the primary part being designed as a hard component, the dimensional stability of which is greater than that of the secondary part designed as a soft component.

EP 0 857 116 B1 discloses a pane unit for windows of motor vehicles and the like, which is provided with a frame made from plastic which has a specific cross-sectional profile. This pane unit is inserted with the aid of its frame into a predetermined orifice of the motor vehicle and is fastened therein. The frame is formed from two profile parts, of which the primary profile part positively surrounds the marginal region of the glass pane on three sides. The frame is produced by injecting a plastic for the primary profile part around the pane. A secondary profile part with further profile portions is subsequently applied to the primary part, so that the pane has a 2-component injection-moulded surround. The secondary part has a lower dimensional stability of its material than the primary part and is sufficiently flexible to form snugly fitting sealing strips. The disadvantage of this pane arrangement is that, in order to produce a pane unit with a guide web, a guide web produced separately beforehand has to be introduced into an injection-moulding die after the attachment of the primary part to the pane, so that the guide web is connected firmly to the pane unit via the secondary part.

s A further known pane arrangement is known from JP 2001-071752 A, the production of a seal around a fixed pane opposite to a movable pane being described. This discloses an injection-moulded surround made from a soft sealing material, in order to connect the fixed pane directly to the body or to seal it off with respect to the frame carrying the movable window. The disadvantage of this arrangement is the complicated manufacture of a window guide web made from resin and rubber which is subsequently fastened to the window and provided with a sealing frame. This means that assembly is difficult. These arrangements, too, have the disadvantage that their webs can be connected to the frame of the pane only subsequently.

The object of the invention, therefore, is to make available a pane unit, by means of which the production and mounting of the pane with a window guide are simplified. The invention relates, moreover, to a method for producing it.

One solution is provided by the features of Claim 1. Alternative embodiments are described in the subclaims.

In the pane unit according to the invention, there is provision whereby the primary part is formed along one longitudinal side of the first pane as a guide web which is arranged or is injection-moulded so as to point towards the pane and engage thereon and has, on the opposite side, a window guide for the displaceable arrangement of a movable second pane. Since the guide web is formed in one piece with the hard component of the injected-moulded surround of the first pane, production can be simplified considerably. On the one hand, there is no need for the guide web to be produced separately in an additional operation and, on the other hand, furthermore, it is unnecessary to introduce this separate guide web into the injection-moulded die before the primary part is injection-moulded as a hard component onto the pane or the secondary part is injection-moulded on.

As an advantageous development of the invention, there is provision whereby, outside a visible region of the fixed pane when the pane unit is in the installed state, fastening elements are produced from the hard component and are integrally formed on the guide web. These may be fastening bores which allow fixing to further fastening elements on the body or else introduced fastening parts, such as screws, threads or the like, whereby fixing to the body can be achieved. In addition, one or more hook elements consisting of the hard component may be provided, adjacently to the injection-moulded surround, in the outer marginal region. This hook element may also act in cooperation with further hook elements on the circumference of the injection-moulded surround as what may be referred to as a shoe fitting, that is to say a back-engaging hook element is formed which with a further hook element forms a fastening. As a result of these alternatives, moreover, simplification in terms of production can be achieved, especially when the hard component itself forms a fastening element.

A further advantageous embodiment is achieved in that the secondary part of the frame at least partially surrounds the primary part and, in the visible region of the pane unit, closes off sealingly on an outside of the pane or on both sides of the pane. On both sides is to be understood above as meaning the inside and the outside of the pane, the secondary part receiving the primary part or the soft component receiving the hard component completely over the circumference or so as to partially surround it. The fastening elements provided are arranged, in the installed state, in the region of the non-visible region of the pane unit and are free of the soft component or of the secondary part. The soft component surrounds the hard component in the visible region, the visible region terminating, in the longitudinal direction, at the bottom somewhat below and at the top somewhat above in the body. Outside the visible region of the pane unit in the installed state, either only the hard component is provided and the hard component is injection-moulded directly onto the pane or the soft component is provided as a visual element and/or a sealing or damping element, for example drawn over or injection-moulded onto the hard component on one side.

A preferred embodiment is achieved in that the hard component has in cross section, perpendicularly to the longitudinal axis, concave indentations towards the first pane, which are provided on one side or on both sides and over which the secondary part or the soft component engages. The secondary part engages on both sides over these indentations of the primary part with a longitudinally guided bead, so that, in the case of a form-fit arrangement of the hard components with the pane, an additional press-down action of the portions of the primary part which bear against the side face of the window pane is brought about. It is advantageous in this case that the sealing-off action of the primary part can thereby be improved. There is provision in this case whereby the indentation may be formed both in the visible region and in the non-visible region and may be covered with the secondary part.

There is preferably provision, further, whereby the primary part is connected to the first pane by means of a primer or an adhesive. The primer or the adhesive is in this case applied to the pane before the application of the primary part. This refinement likewise improves the sealing action.

Alternatively, there may be provision whereby, instead of applying a primer or an adhesive in the region of the frame surrounding the pane, the primary part is injection-moulded directly onto the pane, and whereby the primary part bears positively against the pane margin or surrounds this and thus achieves a sealing-off action.

A preferred embodiment is provided in that the guide web is connectable to at least one panel element subsequently mountable thereon. This embodiment makes it possible, according to the respective decorative requirements, to fasten an appropriate panel element subsequently to the guide web after the first pane has been installed.

There is provision, further, whereby the guide web and/or the panel element have/has for fastening to one another at least one bearing face and/or mutually assigned matching holding elements free of an injection-moulded surround. In this case, an outside of the guide web remains free, so that a panel element can be placed onto the free outside of the guide web and, if appropriate, so as to overlap part of the adjacent injection-moulded surround. The same applies in a similar way should an inner panel be attached. The fastening of the panel element to the guide web may take place, for example, with a partial injection-moulded surround or by adhesive bonding. Clamping, locking, snap fastening, clasping or the like are likewise possible. Furthermore, claw fastening, interlocking, snap connection or keyhole fastening may be provided.

As an advantageous embodiment, there is provision whereby the guide web and/or the panel element form/forms at least one U-shaped guide face for the window guide of the second pane. In this case, the guide face may be formed by a U-shaped profile in the direction of the end face of the second pane. Alternatively or additionally, the panel element may cooperate with the web such that together they form a U-shaped profile.

The further object on which the invention is based is achieved by means of a method according to the features of Claim 9. Design variants are described by the following subclaims.

This is achieved by means of the following method steps: the guide web and a primary part of a frame of the pane unit are injection-moulded as a hard component, preferably jointly, onto the first pane. The primary part is injection-moulded around, in a visible region of the pane unit in the installed state which points at least towards the outside of the vehicle, with a secondary part which is applied sealingly at least to the outside of the first pane. It thereby becomes possible for the introduction of a window guide web to be integrated into the method for producing a two-component or multi-component injection-moulded surround, and the separate production of a window guide web and making it available for introduction into an injection-moulding die to be unnecessary.

In a further preferred refinement of the method, fastening elements are integrally formed and/or introduction parts are integrated on the primary part. Preferably, these fastening elements are formed directly from the primary part. For example, through-bores or holding tabs with through-bores, into which clips for fastening to the body can be inserted, may be provided. Further fastening techniques may likewise be envisaged, in which the fastening elements consist directly of the hard component. Additional introduction parts may likewise be provided which are at least partially injection-moulded around by the primary part, so that they are held, firmly integrated, in the injection-moulded surround.

Furthermore, it is preferably proposed that at least one bearing face for the bearing of the panel element is formed, free of any injection-moulded surround, on the guide web. By virtue of this advantageous refinement, it becomes possible for a pane unit to be able to be formed as a basic module, a specific panel being selected subsequently and fastened to the pane unit, depending on design requirements.

In a further preferred design variant, there is provision whereby at least one holding element for receiving the panel element is integrally formed onto the guide web. The holding element is formed by snap fastening, claw fastening, keyhole locking, locking introduction part or adhesive bonding.

The invention is explained below by virtue of the drawings in which:

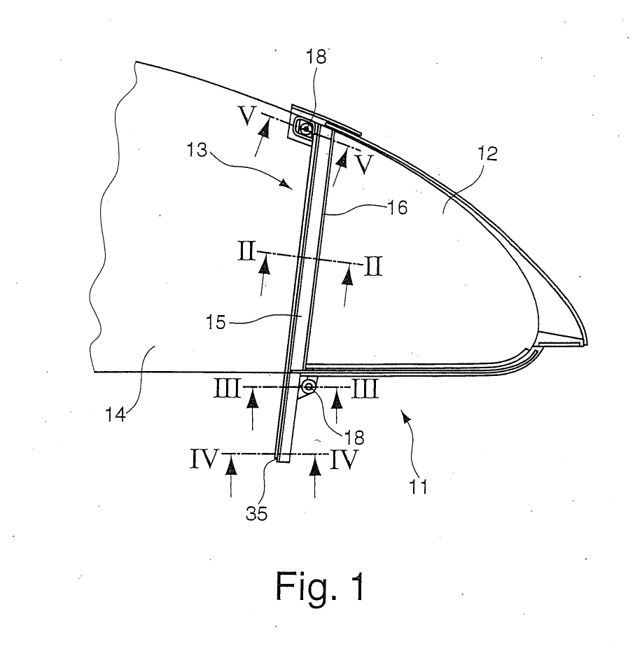

FIG. 1 shows a diagrammatic side view of the pane unit on a side lying on the outside on the vehicle,

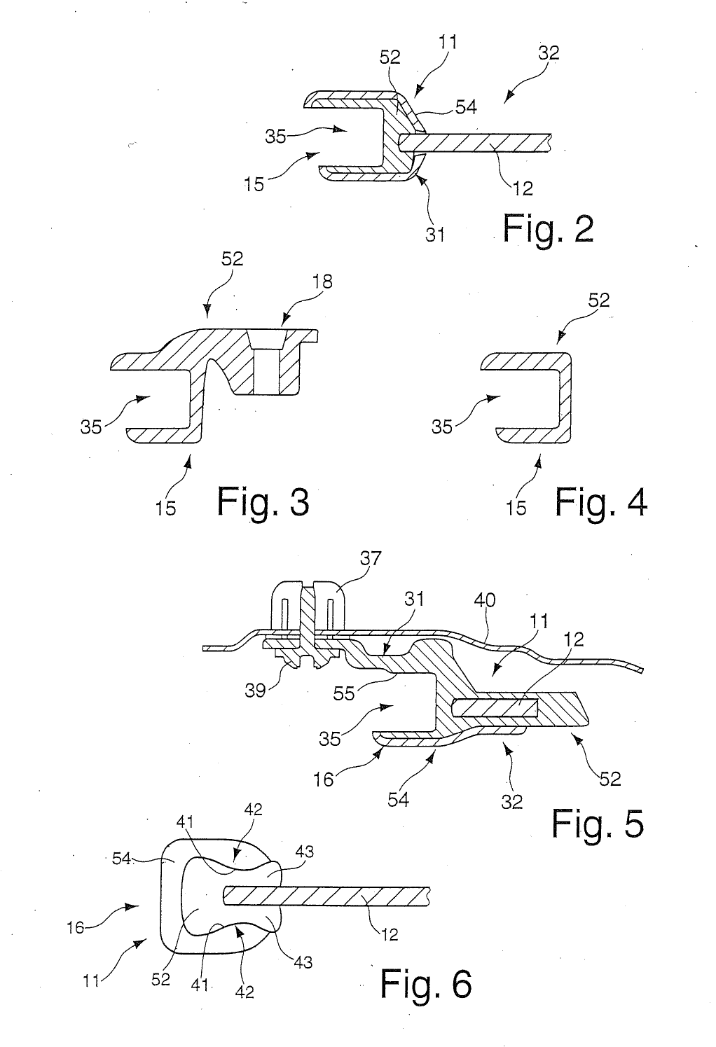

FIG. 2 shows a guide web of the pane unit in cross section according to section II-II of FIG. 1,

FIG. 3 shows the guide web of the pane unit in cross section according to section III-III of FIG. 1,

FIG. 4 shows the guide web of the pane unit in cross section according to section IV-IV of FIG. 1,

FIG. 5 shows the guide web of the pane unit in cross section according to section V-V of FIG. 1,

FIG. 6 shows a frame surrounding a pane of the pane unit in cross section perpendicular to the longitudinal direction,

FIG. 7 shows alternative embodiments of the guide web of the pane unit in cross section perpendicular to the longitudinal axis of the web according to section II-II in FIG. 1,

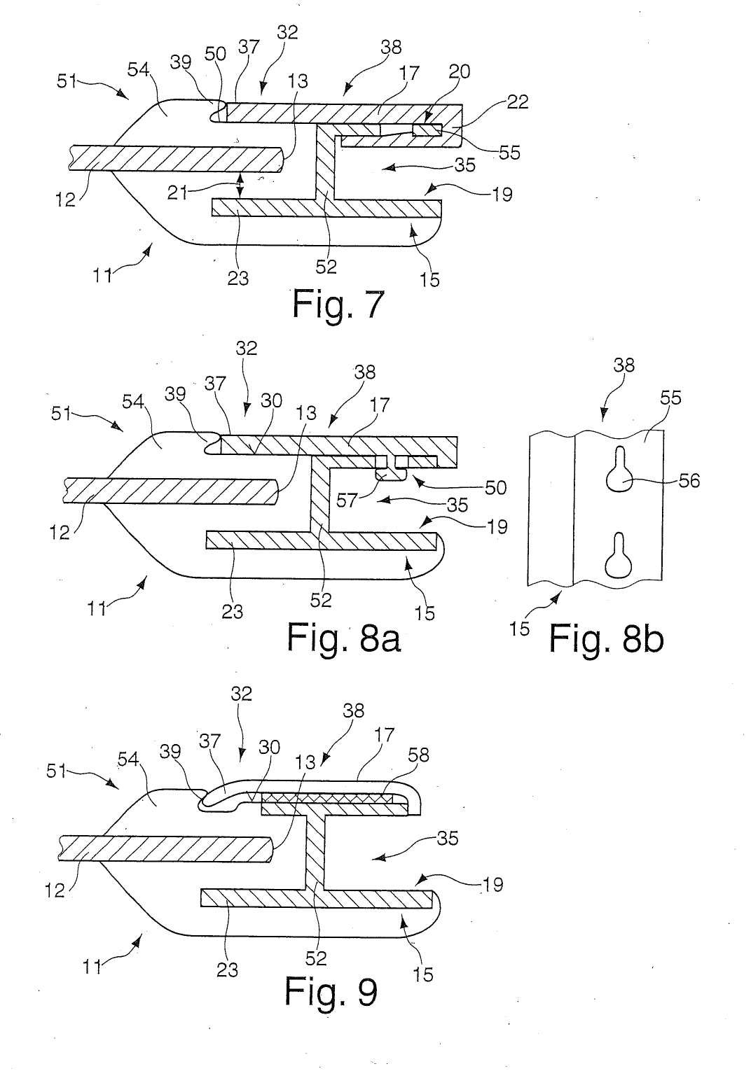

FIG. 8 shows a further alternative embodiment of the guide web of the pane unit in cross section perpendicular to the longitudinal axis of the guide web according to section II-II in FIG. 1, and

FIG. 9 shows a further alternative embodiment of the guide web of the pane unit in cross section perpendicular to the longitudinal axis of the guide web according to section II-II in FIG. 1.

FIG. 1 shows a pane unit 51 in a side view of the side lying on the outside on the vehicle. This pane unit 51 comprises a first pane 12 which is mountable, for example, fixedly in the rear door of a motor vehicle. In this case, the first pane 12 is assigned to the vertical end face 13 of a second pane 14 movable up and down. The pane 12 or the pane 14 may be produced from silica glass, acrylic glass or the like.

Between the first pane 12 and the second pane 14, a guide web 15 is arranged, which continues downwards into the body of the door beyond the end face 13 of the first pane 12, in order to guide the second pane 14 to the greatest possible extent or completely in the opened state. The first pane 12 comprises an injection-moulded surround 16 which, in the exemplary embodiment, completely surrounds the triangular pane 12. Alternatively, there may be provision whereby the injection-moulded surround 16 does not surround the pane 12 completely, that is to say is not designed to run around completely, but instead comprises only individual side portions. The injection-moulded surround 16 forms a frame in which a window guide web 15 is integrated, as illustrated in more detail below by means of FIGS. 2 to 5.

The frame 11 preferably consists of a two-component injection-moulded surround with two profile parts 52, 54, specifically the primary part 52 consisting of a hard component and the secondary part 54 consisting of a soft component, the soft component having lower dimensional stability than the hard component. In the section illustrated in FIG. 2, the secondary part 54 surrounds the primary part over the entire circumference. Only the window guide 35, which is provided in the guide web 15 and is designed as a U-profile, is not covered by the secondary part 54. Alternatively, there may be provision whereby a secondary part 54 is not provided on an inside 31 of the pane unit 51. On the opposite outside 32, the secondary part 54 preferably directly adjoins the pane 12 and seals this off. This is advantageous preferably when the primary part 52 is only injection-moulded onto the pane 12, without a primer or adhesive being applied beforehand.

The guide web 15 is designed as part of the frame 11. This cross section in FIG. 2 shows that the guide web 15 and the frame 11 or the primary part 52 of the frame 11 are integrated one in the other and consist of the hard component. The guide web 15 is formed virtually simultaneously with the production of the primary part 52.

Materials which are described by way of example in EP 0 857 116 E1 are selected as materials for the injection-moulded surround 16, for example as a hard component for the primary part 52 and as a soft component for the secondary part 54.

FIG. 3 shows the guide web 15 in cross section according to section III-III of FIG. 1. The section in this case passes through the guide web 15 and a fastening means 18. The section III-III is outside the visible region of the pane unit 51 in the installed state. In this region, the guide web 15 is produced solely from the hard component. At the same time, the fastening means 18 is formed, for example, as a fastening bore or snapholder from the component and is integrally formed directly onto the guide web 15. This refinement has the advantage that greater efficiency in terms of production is made possible. Surrounding the guide web consisting of the primary part 52 with the secondary part 54 by injection moulding may be provided, especially when in this case a damping or sealing action is also to be achieved in addition.

FIG. 4 shows a sectional illustration along the section IV-IV in FIG. 1. The primary part 52 solely forms the guide web 15 with the window guide 35.

FIG. 5 illustrates a further tie-up point for fastening the pane unit 51 to the body in the section V-V according to FIG. 1. This section shows part of the pane 12 which is surrounded by the primary part 52 in order to form the injection-moulded surround 16. On the outside 32, the secondary part 54 is injection-moulded on the primary part 52 in order also to satisfy visual demands. Appropriate plane or glossy surfaces with a high design quality can be formed by means of the secondary part 54 produced as a soft component. A fastening means 18, which likewise consists of the hard component, is integrally formed directly on a web 55 of the window guide 35 of the guide web 15. The outside of this web 55 is formed without a secondary part 54, since it points directly towards the body 40 and is not visible outwardly. The fastening means 18 may serve, for example, for receiving a fastening element 39, in particular a screw, which can be fastened into a clip 37 inserted into the body 40.

In the above sectional illustrations according to FIGS. 2 to 5, a window guide element insertable into the window guide 35 and intended for receiving the movable pane 14 is not illustrated in any more detail. This window guide element is fastened therein by clamping, adhesive bonding or snapping. This window guide element also serves at the same time as a seal for the movable pane 14.

FIG. 6 illustrates an alternative embodiment of a frame 11 of an injection-moulded surround 16 for the pane 12. In this embodiment, there is provision whereby the primary part 52 is injection-moulded directly onto the pane 12, without an adhesive or a primer being used in this case in order to glue the primary part 52 to the region surrounding the pane margin. Instead, for sealing off on an outside or on both outsides of the primary part 52, a concave indentation 41 is provided, over which the secondary part 54 extends and forms a bead 52 which engages into the indentation 41. However, the secondary part 54 does not in this case extend directly as far as the pane 12 and overlaps that region of the primary part 52 which is directly adjacent to the pane 12. This arrangement achieves a kind of clamp effect, with the result that the two portions 43 of the primary part 52 which bear against the side face of the pane 12 bear under pressure against the side face of the pane 12 and achieve a sealing-off action.

FIG. 7 illustrates an alternative design variant of the pane unit 51 in cross section perpendicular to the longitudinal axis of the guide web 15 according to section II-II in FIG. 1. In this embodiment, there is provision whereby a panel element 17 which can be applied subsequently is attached to the outside 32 of the pane unit 51. For this purpose, in a similar way to the embodiment above, the primary part 52 is designed to engage directly on the pane 12. For the reception and subsequent fixing of the panel element 17, in a web 55 of the guide web 15 a fastening orifice 45 is provided, at which the panel element 17 can be latched via a latching element. The panel element 17 in this case has a U-shaped end portion, the inside of which engages completely into the window guide 35 and forms a U-shaped window guide. Thus, this panel element 17 can be pushed on by being pushed on the primary part 52, which at the same time also forms the guide web 15, and can be fixed in a reception region 38. At the opposite end 47, the operating element 17 can be directly adjacent to the secondary part 54, so that a visually pleasing arrangement is afforded. Alternatively, the secondary part 54 may also engage partially over the end 47 in order to hold down this end 47 of the panel element 17, so that firm bearing contact against the primary part 52 is provided. FIG. 8 illustrates an alternative embodiment of a pane unit 51 with a panel element 17 which can subsequently be arranged on an outside 32 of the frame 11. In this alternative embodiment, there is provision whereby the primary part 52 does not extend along both side faces of the pane 12 at the marginal region, but instead bears against and engages on only one side face and one end face of the pane 12. This alternative embodiment may also be provided for the above-described exemplary embodiment and for the exemplary embodiment yet to be described below.

This panel element 17 is fastened to the guide web 15 by means of a fastening possibility alternative to that of FIG. 7. For example, a keyhole locking, as it is known, may be provided, in which a locking pin 49 or a plurality of locking pins 49 arranged on the inside of the panel element 17 engage at a fastening orifice 45 designed as a keyhole, as illustrated in FIG. 8b.

FIG. 9 illustrates a further alternative embodiment to FIGS. 7 and 8. In this embodiment, the panel element is fastened to the primary part 52, for example, via a double-sided adhesive tape or an adhesive bond 48. The panel element 17 itself may, for example, engage over the end face of a web 55 of the guide web, in order to form a visually pleasing transition to the movable pane 14. This refinement may also be provided in the above embodiments.

Any desired combination of the individual features and

FIGS. 7 to 9, insofar as these are technically expedient, may likewise be provided.

The embodiment according to the invention of a pane unit 51, in which both the guide web 15 and the primary part 52 are produced from the hard component, thus makes it possible, on the one hand, to configure the visible side of the guide web 15 by means of the secondary part 54 in a two-component or multi-component injection-moulded part or to attach and apply a panel element 17 subsequently.

In all the embodiments described above, the production of the pane unit 51 takes place in that the guide web 15, as hard component, is injection-moulded simultaneously with the primary part 52 onto the first pane 12, the operation of injection-moulding the secondary part 54 as soft component taking place subsequently in the second step. Alternatively, there may also be provision whereby the primary part 52 and the guide web 15 are produced separately from the hard component in an injection-moulding operation simultaneously or in succession, so that subsequently, in a second step, the guide web 15 and the primary part 52, which form a portion of the frame 11 for the pane 12, are connected to one another by means of the secondary part 54. This arrangement is likewise possible and has the advantage that separate production of the guide web 15 and separate introduction into an injection-moulding die are unnecessary.

This application claims priority of German Patent Application No. 10 2010 061 103.4 filed Dec. 8, 2010, which is hereby incorporated herein by reference in its entirety.

1. Pane unit for windows on motor vehicles and the like,
with a first pane,
with a frame which has a frame profile and surrounds the margin of the pane on at least two sides, the frame engaging on at least two sides of the pane or annularly surrounding the pane so as to be closed on itself, and
the frame is formed from two profile parts with a primary part and with a secondary part, and
the primary part is formed as a hard component, the dimensional stability of which is greater than that of the secondary part formed as a soft component, wherein
the primary part is formed along one longitudinal side of the first pane as a guide web for a second pane movable up and down therein, which guide web is arranged so as to point towards the first pane and engage thereon and has, on the opposite side, a window guide for the displaceable arrangement of the movable second pane.

2. Pane unit according to claim 1, wherein outside a visible region of the pane unit in the installed state, fastening elements, are produced from the hard component and are integrally formed on the guide web.

3. Pane unit according to claim 2, wherein the fastening elements are bores, threads, introduction parts or shoe fittings.

4. Pane unit according to claim 1, wherein the secondary part of the frame at least partially surrounds the primary part and, in the visible region of the pane unit, closes off sealingly on an outside of the pane or on both sides of the pane.

5. Pane unit according to claim 1, wherein the primary part has in cross section, perpendicularly to the longitudinal axis, concave indentations towards the first pane, which are provided on one side or on both sides and over which the secondary part engages.

6. Pane unit according to claim 1, wherein the primary part is connected to the first pane by means of a primer or an adhesive.

7. Pane unit according to claim 1, wherein the guide web is connectable to at least one panel element subsequently mountable thereon.

8. Pane unit according to claim 6, wherein the guide web and/or the panel element have/has for fastening to one another at least one bearing face and/or mutually assigned matching holding elements free of an injection-moulded surround.

9. Pane unit according to claim 6, wherein the guide web and/or the panel element form/forms at least one U-shaped window guide for the second pane.

10. Method for producing a pane unit according to claim 1, wherein following method steps: a guide web and a primary part of a frame of the pane unit are injection-moulded as a hard component onto the first pane, and the primary part is injection-moulded around, in a visible region of the pane unit which points at least towards the outside of the vehicle, with a secondary part which is applied sealingly at least to the outside of the first pane.

11. Method for producing a pane unit according to claim 10, wherein fastening elements are integrally formed and/or introduction parts are integrated on the primary part.

12. Method for producing a pane unit according to claim 10, wherein at least one bearing face for the bearing of the panel element is formed, free of an injection-moulded surround, on the guide web.

13. Method for producing a pane unit according to claim 10, wherein holding elements for receiving the panel element are integrally formed onto the guide web.

14. Method for producing a pane unit according to claim 13, wherein the holding elements are formed as a snap fastening, claw fastening, keyhole locking or by at least one introduction part or are produced as an adhesive bond.
